(19) United States
(12) Patent Application Publication
(10) Pub. No.: US 2010/0228404 A1
(43) Pub. Date: Sep. 9, 2010

(54) Method and system for configuring and provisioning a vehicle

(76) Inventors: Charles M. Link, II, Atlanta, GA (US); Dane Dickie, Atlanta, GA (US); Michael Peterson, Atlanta, GA (US); Marc Gordon, Atlanta, GA (US); Paul Kirsch, Dusseldorf (DE); Kevin Link, Atlanta, GA (US); Mike Vadney, Atlanta, GA (US)

Correspondence Address: HUGHES TELEMATICS, INC., 2002 Summit Blvd, Suite 1800, ATLANTA, GA, 30319, US

(21) Appl. No.: 12/719,756

(22) Filed: Mar. 8, 2010

Related U.S. Application Data
(63) Continuation-in-part of application No. 12/467,960, filed on May 18, 2009.
(60) Provisional application No. 61/158,293, filed on Mar. 6, 2009.

(51) Int. Cl. G06F 17/00

(52) U.S. Cl. 701/1

(57) ABSTRACT

A telematics method and system facilitates customizing a plurality of vehicle content files, parameters, and features based on edits and selections from a user interface. A telematics provider maintains a database comprising a table, or tables that associate(s) user identification information with a vehicle VIN and equipment/features/content installed in/on vehicle devices associated with the VIN. Database updates may occur automatically, or upon a user instruction, when a TCU wirelessly transmits current equipment, content, and feature configuration information to a TOC coupled with the database. The telematics provider's server may provide the interface that facilitates the user logging in and editing features, content, and operational and performance parameters currently configured/installed in/on the vehicle' equipment and devices. The telematics provider may forward the user input from the interface to another provider after it verifies user log in credentials before the other provider begins a download to vehicle devices associated with the VIN.

### CROSS REFERENCE TO RELATED APPLICATION

This application claims priority under 35 U.S.C. 119(e) to U.S. provisional patent application No. 61/158,293 entitled “Method and system for remotely configuring a telematics system,” which was filed Mar. 6, 2009, and which is incorporated herein by reference in its entirety. This application also claims priority under 35 U.S.C. 120 to U.S. patent application Ser. No. 12/467,960 entitled “Method and system for automatically provisioning a device and registering vehicle modules with a telematics services provider,” which was filed May 18, 2009, and which is incorporated herein by reference in its entirety.

### FIELD

The present invention relates to telematics systems, and more particularly to updating and maintaining a listing of vehicle equipment and corresponding supported features and capabilities, and providing an interface that a user can, remotely from the vehicle, select features and customize the operation of the equipment, software, features, content, performance, and functionality of the vehicle.

### BACKGROUND

Telematics refers to the integrated use of telecommunications devices and systems and information storage, usage, transmitting, receiving, and processing. More simply, telematics refers to sending, receiving and storing, information via telecommunication devices. In addition, telematics devices and system have been applied alongside Global Positioning System (“GPS”) technology integrated with computers and mobile communications technology in automotive information and navigation systems.

Other than the convergence of telecommunications and information processing, the term telematics may also refer to automation of various services and processes relating to the driving and using of automobiles. For example, a telematics system can report emergency situations to a telematics services provider's central location via a voice telephony call over a wireless communications network, or a message sent electronically over a network, including a wireless communications network and the interne. Telematics also includes services such as GPS navigation, integrated hands-free cellular telephony, wireless safety communications, and automatic driving assistance and information systems, such as traffic, restaurant, fuel, and vehicle diagnostic and emissions information. IEEE standard 802.11p refers to Wireless Access for the Vehicular Environment to facilitate and enhance Intelligent Transportation.

A telematics services provider (“TSP”) typically operates a call center with live operators to respond to emergency calls and to contact the appropriate responders to the emergency. The TSP also typically has a telecommunications operations center (“TOC”), which typically includes a computer server and other networking equipment to connect the server with various networks, such as the internet. A telematics control unit (“TCU”) installed in a vehicle, either at the time of manufacture, or after the vehicle was placed in service, typically contains a GPS portion, a cellular telephony portion, and general computer electronics such as a memory, a general processor, I/O interface, etc., which are coupled to the GPS and to the cellular, or wireless, telephony portion.

A subscriber typically pays a monthly services charge to a TSP. The TSP typically establishes and maintains a wireless services subscription with a wireless carrier, such as a cellular telephony services provider, so that the TCU can communicate with the TOC via wireless communication networks and the internet. This connection also facilitates interne availability and functionality for a subscriber at the TCU. In addition, internet connectivity facilitates a subscriber transmitting and receiving information between his car and a personal computer, or other computer device connected to the interne, either wirelessly or with a wired connection.

A TSP typically establishes an account with a wireless carrier (can also be referred to as activating or provisioning an account) so that a TCU can communicate across the wireless carrier's wireless (typically cellular) network. After a TCU has been installed in a vehicle, the vehicle's manufacturer, or the retail dealer selling the vehicle, typically obtains a unique identifier of the TCU and unique identifier information corresponding to the wireless telephony portion of the TCU. The unique identifier of the wireless telephony portion typically includes an International Mobile Subscriber Identity (“IMSI”) for mobile units using GSM technology, or a Mobile Subscriber Identifier (“MSID”) for mobile units that use CDMA technology. The TSP may manually obtain the mobile unit's unique identifier and manually forward it to a wireless carrier via a voice telephone call, or writing on a paper form and mailing, or sending via facsimile to the wireless carrier. The wireless carrier begins billing the TSP for wireless service for the TSP.

A TSP typically does not keep track of the location of a given TCU and thus does not know when it has been, or will be, installed in a vehicle. Thus, the TSP typically establishes, or provisions, service for a given TCU soon after receiving notice from the TCU manufacturer that the TCU has been made. However, a wireless carrier begins billing a TSP for wireless service for a given TCU after that TCU has been provisioned, even if the TCU has not been installed in a vehicle. In addition, a given TCU may have been swapped out from a given vehicle for another TCU after the vehicle has been manufactured. The removed TCU could either sit idle on a shelf, or more likely, be installed in another vehicle owned by someone not paying for a subscription to the TSP services. Also, the various modules in a vehicle may be changed during, or after, manufacture of a vehicle, and manual record keeping procedures typically used do not adequately track the location of a given module.

As telematics systems system grow in capabilities with respect to performance and the services that they can provide, or facilitate, users and service providers more and more desire flexibility in configuring a telematics system. A services provider that bills a subscriber monthly may offer many services, which may be bundled together as part of a predetermined plan. Or, a subscriber may select certain services from the services offered by the provider to fit his, or her, needs and budget. Typically, when a subscriber enters an agreement for services with a provider, the subscriber either places an order by manually filling out a form and signing it, or, by placing the order via telephone and providing a credit card account number for billing.

However, as anyone who has attempted to place, or modify, an order for any kind of good or service via telephone, after waiting a long time to speak to a sales person, the sales person often enters the order incorrectly. Accordingly, a subscriber may have a disincentive to experiment with new services as they become available, or to change the subscription package from month to month. Furthermore, a subscriber may not want to interface with a live order taker for privacy purposes. Thus, there is a need in the art for a method and system that facilitate placing, and modifying, subscription services that do not require interfacing with sales personnel of the services provider.

Thus, the art needs a method and system for automatically provisioning wireless service for a TCU after its corresponding vehicle has been manufactured. Furthermore, the art needs a method and system for deactivating wireless service for a TCU after it has been removed from a vehicle, or otherwise loses association with a subscriber paying for telematics services.

In addition, the art needs a method and system for automatically registering, updating, and centrally maintaining a list of, various modules, software, and content installed in, configured in, and provisioned in a vehicle.

### SUMMARY

A method for automatically configuring a telematics control unit for use in a vehicle comprises receiving a unique identifier of the telematics control unit and subscriber identity information that corresponds to the telematics control unit. Typically, a TSP's TOC service receives the unique identifier and the subscriber identity information. The TOC associates the unique identifier of the telematics control unit and the subscriber identity information corresponding to the TCU with a unique identifier of the vehicle. Typically, the vehicle unique identifier is a vehicle's vehicle identification number (“VIN”). The method may further comprise receiving equipment information corresponding to a set of vehicle equipment associated with the telematics control unit, and associating the received equipment information with the unique identifier of the vehicle. The vehicle equipment associated with TCU may include various system control modules onboard a vehicle. The vehicle equipment may also include the TCU.

To automatically register equipment modules and update an equipment information table with equipment information of a vehicle, the TCU may seek a wireless signal, for example a GPS signal. If the TCU can tune a GPS signal, it has probably been installed in an assembled vehicle which has left its manufacturing facility (otherwise, the vehicle assembly plant building would probably block, or severely attenuate, GPS signals transmitted from satellites orbiting the earth. After the TCU has detected a GPS signal, the TCU acquires equipment information from equipment devices, for example various system control modules, installed in the vehicle. A TCU also perform this step of acquiring equipment information multiple times during the days, months, and years, after the vehicle it has been installed it has first detected a GPS signal (thus indicating that the vehicle has left its assemble plant). Typically, the TCU re-acquires equipment information from the vehicle after each predetermined number of vehicle crank-ups occur.

After the TCU acquires equipment information whether at first crank-up after leaving a vehicle's assembly plant, or at subsequent crank-ups, the TCU updates the equipment information table with equipment information corresponding to one, or more, equipment devices installed in the vehicle, and wirelessly transmits the equipment information in the table to a central server of a telematics services provider.

A TCU typically comprises a processor circuit coupled to a plurality of vehicle equipment modules. A memory is coupled to the processor. A portion of the memory is configured to store a table of equipment information corresponding to the plurality of vehicle equipment modules. A first wireless circuit coupled to the processor is configured for wirelessly receiving location information corresponding to a present location of the telematics control module. A second wireless circuit is coupled to the processor, which is configured to generate an equipment information message containing the equipment information associated with the VIN of the vehicle. The processor is configured to cause the second wireless circuit to wirelessly transmit the equipment information message to a central server of a telematics services provider.

Another aspect includes associating, either automatically or manually, a listing of equipment installed in a given vehicle with the vehicle's VIN. A user's login identifier(s)/credentials may be associated with the VIN and the listing of equipment also. In addition, the features that the equipment supports may also be associated with the VIN in a database, or via an online table lookup based on a manufacturer's database that associates features and capabilities with a piece of equipment's model number and serial number.

### BRIEF DESCRIPTION OF DRAWINGS

FIG. 1 illustrates a system for making and installing a telematics control unit in a vehicle and automatically and wirelessly registering the vehicle's module.

FIG. 2 illustrates identifiers and other information stored into a telematics unit during its manufacture.

FIG. 3 illustrates a flow diagram of a method for provisioning a TCU with a wireless carrier.

FIG. 4 illustrates a flow diagram of a method for assembling a vehicle with a TCU.

FIG. 5 illustrates a flow diagram of a method for updating a vehicle equipment information table.

FIG. 6 illustrates a user using a telematics system for selecting features related to his telematics services plan, or related to his vehicle's installed equipment, software, or content.

FIG. 7 illustrates a flow diagram of a method for facilitating selecting custom features and aspects related to a user and the user's vehicle based on equipment, software, and content installed in the vehicle.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

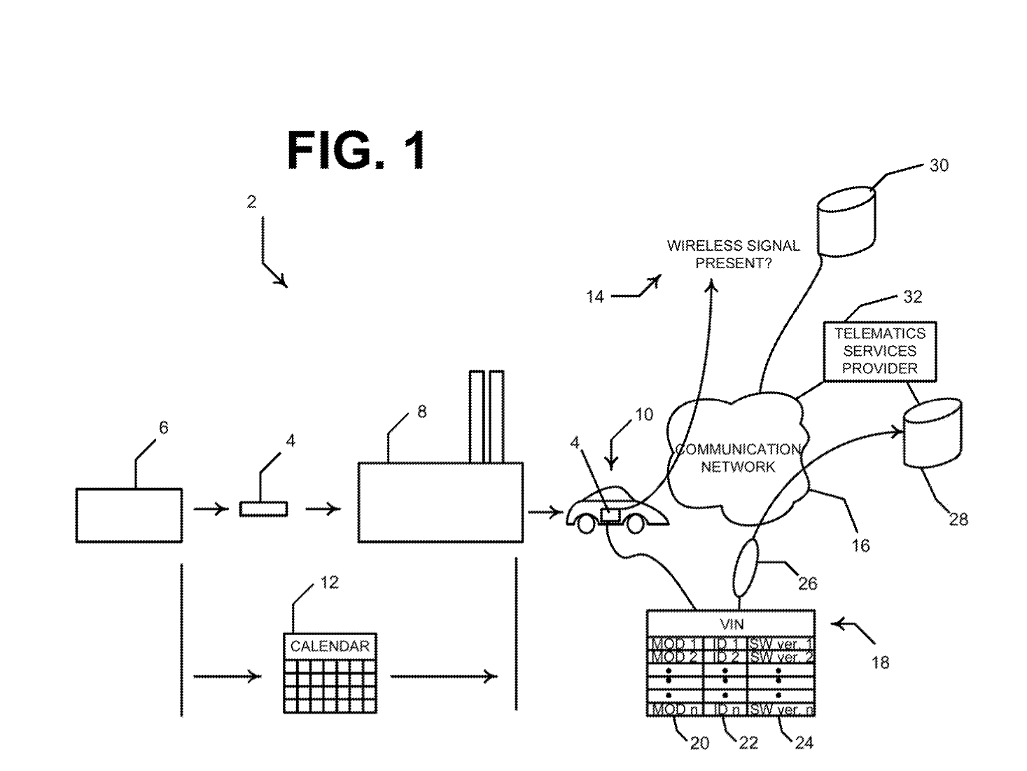

Turning now to the figures, FIG. 1 illustrates a system 2 for wirelessly and automatically registering a vehicle with a telematics services provider (“TSP”). A manufacturer makes a telematics control unit (“TCU”) 4 at a factory 6. After manufacture, TCU 4 travels to an original equipment automobile manufacturer's (“OEM”) assembly plant 8. Although TCU manufacturer 6 and OEM 8 may be collocated, typically, these plants are located in geographically distant locations from one another. Often, the two plants are located in different countries. Thus, the period beginning when TCU 4 leaves plant 6 and then an assembled vehicle 10 with TCU 4 in it leaves plant 8 typically comprises a number of days 12. For purposes of discussion, the period between a TCU leaving plant 4 and then leaving plant 8 in an assembled vehicle 10 is referred to as a registration offset period 12.

A telematics services provider can predetermine provisioning offset period 12, so that after the provisioning offset period elapses following manufacture of a TCU, the telematics services provider's centrally located server automatically establishes an account for the TCU with a wireless services carrier, such as a cellular telephony carrier (e.g., Verizon, Inc. or AT&T, Inc.). When the telematics services provider establishes the account with the wireless carrier, the telematics services provider arranges for predetermined features and bandwidth capacity so that that use of the telematics system conforms to terms previously agreed to by the wireless carrier for subscribers of the telematics services.

For example, a TCU typically comprises a cellular telephone circuit and a global positioning satellite (“GPS”) circuit. Upon crank-up, the TCU seeks a signal compatible with its circuitry. The TCU also seeks a wireless system identifier, sometimes referred to as a SID when used in a CDMA (CDMA-2000) network, or a Mobile Country Code+Mobile Network Code (i.e., MCC+MNC) if used in a Global System for Mobile communications (“GSM”) system device. If a manufacturer makes a TCU for operation according to code division multiple access (“CDMA”), the TCU would not recognize a signal and ID from a GSM transmitter, and vice versa if the TCU was made for use in a GSM network. If the TCU does not detect a compatible SID, MCC, or MCC+MNC combination, then it will not attempt to transmit registration information to the TOC and will return to a deep sleep mode waiting for the next ignition cycle, or vehicle crank-up. However, if the TCU does detect a compatible cellular wireless signal, it will send device and subscriber identity information to the TOC as discussed in more detail below.

Also, following the predetermined provisioning offset period 12 and detection of a GPS signal, TCU 4 may collect information from various control modules installed on vehicle 10. For example, vehicle 10 may include multiple electronic modules such as, for example, an engine control module (“ECM”), a powertrain control module (“PCM”), a transmission control module (“TCM”), a climate control module, a power door locks module, a audio system module, etc. Since each module typically includes similar basic computer circuitry, such as a processor, a memory device, and input and output ports, each module may be generically referred to as an electronic control unit (“ECU”). Each ECU typically has a module name, or type; a unique identifier, or serial number; and current software version. TCU 4 collects this information related to each of the modules onboard vehicle 10 and populates a table 18 with the collected module information. Table 18 associates the vehicle identification number of corresponding to vehicle 10 with the all of the modules identified as MOD 1-MOD n in module name field 20. Identifier and software version fields 22 and 24, respectively, contain the unique identifiers and current software versions of each of modules MOD 1-MOD n. After TCU 4 has built table 18, it formats the table into a message 26 and transmits it across communication network 16 using a wireless link with a wireless provider 30 that generated the signal and the acceptable MCC+MNC or SID that the TCU sensed as being present after it woke up. The TCU transmits the signal to a server 28 operated by telematics services provider 32. One skilled in the art will appreciate that server 28 may be connected to network 16 via a wired, or wireless, link. The ‘cloud’ symbol used in the figure to represent network 16 can represent a wired network such as the internet, and a wireless network such as, for example, a wireless CDMA or GSM cellular network, a GPS network, a Wi-Fi network, and networks using other communication protocols known to those skilled in the art.

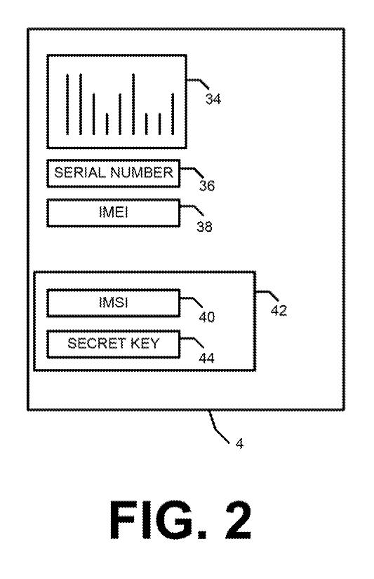

Turning now to FIG. 2, the figure illustrates typical information stored on a TCU. A bar code 34 corresponding to serial number 36 uniquely identifies the individual TCU. An OEM reader can read bar code 34 during assembly of a vehicle and associate the VIN of the vehicle with the serial number of the unit installed in the vehicle. An International Mobile Equipment Identity (“IMEI”) 38 also uniquely corresponds with a particular TCU, and in some cases a TCU maker may include the IMEI in serial number 36. Preferably, the TCU automatically requests, detects, and stores, the VIN from one of the ECUs, typically, the ECM, when the OEM factory first turns on, or cranks up, the vehicle containing the TCU.

An International Mobile Subscriber Identity (“IMSI”) 40, also a unique number, is associated with, and corresponds to, a particular user's account. In addition, a subscriber identity module (“SIM”) 42 typically contains one, or more, secret keys 44. A TCU manufacturer typically permanently fixes a SIM into a TCU, and the TCU sends SIM information 42 to a telematics services provider via an “electronic data interchange” EDI link. The OEM associates the device identifier, either the serial number 36, the IMEI (or MEID) 38, or both, with the corresponding vehicle's VIN and sends the device identifier and associated VIN to the telematics services provider. Preferably, the TCU transmits VIN, and corresponding TCU device information and SIM information to the telematics services provider automatically when the vehicle is cranked. However, the TCU does not perform a first-time-after-assembly transmission of vehicle equipment information until the TCU detects the presence of a GPS signal. This prevents the TCU from attempting to transmit information while still inside an OEM's factory.

If the TCU has never detected a GPS signal, and cannot detect one, the vehicle is probably still inside a factory building that blocks GPS signals. An OEM may make changes to an ostensibly complete vehicle before it leaves a factory building. Waiting until the TCU detects a GPS signal reduces the likelihood that the TCU will use wireless air-time minutes (which a telematics services provider pays for) to transmit a vehicle's equipment information that may change after the vehicle leaves a factory. When the telematics services provider receives the SIM information 42 and the vehicle TCU identifier information associated with a vehicle's VIN, it creates a new record in a telematics operation center server (such as server 28 shown in FIG. 1) using the VIN as the record identifier. Alternatively, the TOC server may already contain a blank record corresponding to the subscriber identity information contained in the SIM. The telematics services provider indexes the table according to VIN number, and stores future information it receives from a TCU according to VIN. Thus, based on VIN, table 28 at the TOC associates TCU unique identity information, user's (typically the vehicle's purchaser, or owner) account information, and the vehicle module information received in message 26 as shown and described above with respect to FIG. 1.

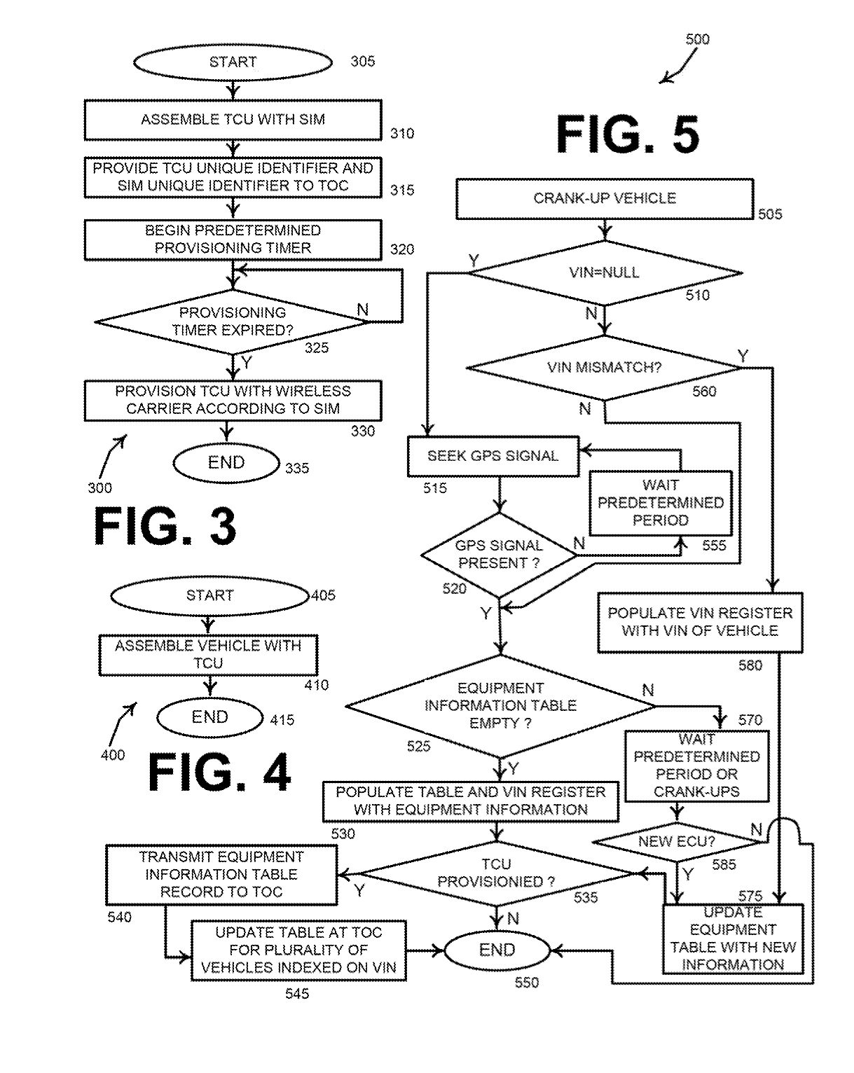

Turning now to FIG. 3, a flow diagram illustrates a method 300 for provisioning a TCU for use over a wireless carrier's network, such as, for example, a cellular telephony network. Method 300 starts at step 305. At step 310, a manufacturer makes a TCU device. During manufacturing, the manufacturer of the TCU installed a SIM in the TCU. Optionally, the manufacturer solders that SIM into the TCU, but a traditional, nonsoldered, SIM card may be installed.

At step 315, the TCU manufacturer provides information to a telematics services provider regarding identifiers of the TCU. For example, the manufacturer may provide the serial number of the device and the associated identifier of the SIM to a telematics services provider's TOC server. The TCU manufacturer may perform step 315 manually, by personnel uploading information from its manufacturing plant to the TOC. Alternatively, the TCU may perform step 315 automatically, while powered up for testing, for example, while still at the plant where the TCU was made. After manufacturing, the manufacturer may set a provisioning timer at step 320. The TCU manufacturer sets the provisioning timer to a predetermined time based on periods for estimated shipment to, and shelf life at, a vehicle manufacturer, for example. After step 325 determines that the timer has counted down, the TOC provisions the TCU by establishing a wireless services account for the TCU based on information uploaded to the TOC at step 315. For example, the wireless provider configures its network equipment to recognize requests for services from the TCU and to provide services in response thereto according to a predetermined rate plan established between the wireless carrier and the telematics services provider. The wireless services carrier establishes the wireless services account for the TCU based on the SIM, and information contained in the TCU. Thus, information in the TCU and SIM, namely a device's identifier and subscriber identify information, such as contained on a SIM in a GSM device, is associated and linked together at the TOC. Method 300 ends at step 335.

Turning now to FIG. 4, the figure illustrates a flow diagram of an OEM assembling a vehicle with a TCU. Method 400 starts at step 405. At step 410, while manufacturing a vehicle, the OEM installs a TCU in the vehicle as a step in the vehicle assembly process. The TCU typically includes a cellular telephony transceiver circuit portion, a GPS receiver, or transceiver, portion, and a main board with a general processor and memory. The cellular and GPS circuitry portions typically couple electrically with the main circuit board, but may connect wirelessly, or via a cable. The TCU manufacturer optionally solders a subscriber identity module to the main circuit board, or to the cellular circuitry board. A SIM card typically includes an IMSI that can be associated with a subscriber account, and thus a cellular services provider can provision, and bill for, use of a TCU according to a plan a subscriber pays for. The TCU manufacturer also associates a serial number, bar code and IMEI with the TCU itself. Thus, an association is made between the identifier (serial number or IMEI) of the device and a subscriber account by associating the IMEI and IMSI with one another. Furthermore, the OEM may associate the TCU IMEI and the SIM IMSI with a VIN of the vehicle, and may store the associated IMEI, IMSI, and VIN together in a database for future reference. Alternatively, when the TOC automatically establishes an account for a given IMSI, or similar identifier used in CDMA networks, the account information is associated with the VIN of a vehicle the corresponding TCU is installed in when method 500 executes, as described below. Method 400 ends at step 415 after the TCU has been installed in the vehicle.

Turning now to FIG. 5, the figure illustrates a method for updating a table at a telematics services provider's centrally located TOC server. Method 500 starts at step 505 when the vehicle is cranked-up. In an aspect, at step 505, near the end of the assembly process as described in reference to FIG. 4, the OEM manufacturer cranks up the vehicle in which it installed a given TCU. When the vehicle cranks-up (or when the vehicle electrical system has been placed into a Run mode) the vehicle electrical system provides power to the TCU. At step 510, the TCU evaluates a register in a portion of its memory that it uses to store a vehicle's VIN. If the TCU determines that the VIN register is null (typically the case when an OEM installs an unused, or reset, TCU in a newly assembled vehicle) method 500 follows the ‘Y’ branch to step 515.

At step 515 the TCU's general processor instructs the GPS circuitry to seek a GPS signal. At step 520, the general processor determines whether the GPS circuitry detected a GPS signal. If a signal has not been detected, the vehicle has likely not left the OEM factory building, which would most likely block GPS signals from reaching the TCU GPS antenna in the vehicle. Thus, if the TCU general processor determines that the GPS circuit did not detect a GPS signal at step 520, method 500 follows the ‘N’ branch from step 520 and waits a predetermined amount of time at step 555. The predetermined wait time of step 555 may be selected to correspond to the assembly time of a single vehicle at the OEM's factory. Even if the vehicle is placed out of Run mode, the processor can operate the wait timer in a low power state. In addition, any desirable time other than vehicle assembly time may be selected for the time for method 500 to wait at step 555. After waiting the predetermined period at step 555, method 500 returns to step 515.

If the TCU general processor determines that a GPS signal was present at step 520, method 500 advances to step 525 and the TCU general processor determines whether an equipment information table portion in the TCU's memory is empty. If the determination at step 525 is yes, method 500 follows the ‘Y’ branch to step 530. Two conditions were met to arrive at step 530—a GPS signal was detected and the vehicle, with the current TCU, was ‘cranked-up’ for the first time in the presence of a GPS signal (if the vehicle had been cranked-up before with the current TCU was installed, the VIN register would not have been null at step 510). The vehicle could have been cranked up in the factory building that shielded the vehicle's TCU from GPS signals. Furthermore, if the vehicle had been cranked in the presence of a GPS signal with the current TCU was installed, the equipment information table would not have been empty and method 500 would have advanced from step 525 to step 570, as will be discussed further below.

Continuing with the description at step 530, the TCU processor requests equipment information from various electronic device modules, or ECUs, used in the vehicle in which it has been installed. Modules used in a vehicle may include an engine control module (“ECM”), a powertrain control module (“PCM”), a transmission control module (“TCM”), and other various modules typically used in modern vehicles, such as airbag modules, seat belt modules, power window and door modules, audio and video system modules, climate control modules, etc. Each module in a vehicle typically has a module name, module unique identifier, and a software version corresponding to the current version of software, or firmware, it is loaded with.

At step 530, while the vehicle is running, or at least in a Run mode, the various modules respond to the TCU's request for information by providing the information associated with them and stored on their individual memories via a bus, or communication means, such as a controller area network (“CAN”) bus, wireless link, or wired link. The TCU receives the response messages from the various modules and stores the information in an equipment information table in the TCU's memory. The TCU also requests, and receives, the VIN from at least one of the modules, and automatically associates the equipment information received from the modules with the vehicle's VIN number in the equipment information table. The VIN may become part of a record in the TCU memory that stores the equipment information. Or, the name of a file that contains the equipment information may be named with the VIN as part of the file name, or other table identifier.

From the equipment information table record, or file, the TCU creates an electronic equipment information message suitable for transmission over a cellular network, or other similar wireless system, or link. At step 535, the TCU determines whether it has been provisioned as described in reference to FIG. 3, by sending a service request message to the wireless services provider according to its network protocol (for example GSM or CDMA) using information and credentials in the TCU's SIM, or similar information in the case of a CDMA-configured device. If the TCU processor determines at step 535 that the TCU has been provisioned for wireless service, it transmits the equipment information message to a telematics services provider's centrally located TOC server at step 540. At step 545, the TOC server updates its master vehicle equipment information table with information in the electronic message transmitted at step 540, and indexes the master vehicle equipment information table according to VIN. In addition, the TOC verifies that the TCU identifier and IMSI (or similar CDMA identifier) associated with a given VIN has not changed from previous information associated with the VIN. If the TCU, or subscriber identity identifiers, has changed with respect to a given VIN, the TOC updates a subscriber table by associating the new information with the VIN. In addition, the TOC stores the old TCU and subscriber identities associated with the VIN in an unused TCU table, or list. Thus, at any time, the TOC can quickly perform a search for the current information regarding the equipment installed in a vehicle corresponding to a given VIN. And, if the TOC determines at step 545 that a TCU device is no longer associated with a given VIN, the telematics services provider can cancel the subscription with the wireless services provider for the account corresponding to the now unused TCU based on that TCU's SIM information, or similar CDMA information. This provides a method for automatically deactivating a TCU if it has been swapped out and replaced with another one. Thus, the telematics services provider does not continue paying for a subscription for a TCU that may have been stolen, or reused in a vehicle owned by someone, or an organization, that has not obtained a subscription with the telematics service provider. Method 500 ends at step 550.

Returning to the description of method 500 at step 525, if the TCU processor determined that the equipment information table was not empty, the TCU waits a predetermined amount of time, or a predetermined number of crank-up cycles of the vehicle at step 570. After waiting at step 570, the TCU processor queries the vehicle CAN bus (or other system for communicating with the various ECU modules on the car) at step 585 to determine if new, or different, modules, or software, have been installed since the TCU last performed step 530, or step 575, as described in more detail below. The various modules in the vehicle respond to the query with equipment information as described above with respect to step 530, namely, module name, or other type identifier; module serial number, or other unique identifier; and module software version. The TCU processor stores the result of the query to the TCU memory and then compares the query results to equipment information stored in the equipment information table. If the results of the comparison indicate that new, or different, modules, or new software, have been installed in the vehicle, method 500 follows the ‘Y’ path and at step 575 the TCU updates its equipment information table record with information regarding new equipment, different equipment, or new or different software, that has been installed since the last time the TCU performed step 530, or step 575. From step 575, method 500 advances to step 535 and continues as described above. If the TCU determines at step 585 that the vehicle does not contain new modules, different modules, or new or different software, method 500 ends at step 550.

Returning to step 560, if a VIN mismatch exists, method 500 follows the ‘Y’ branch and advances to step 530. At step 530, the TCU populates, or updates, the VIN register of the TCU memory and also populates, or updates, the equipment information table with the module names/types, corresponding unique identifiers, and corresponding software versions of the ECU modules used throughout the vehicle.

Steps 575 and 530 differ in that at step 575 the TCU detects differences in information it has stored in the equipment information table from information the CAN bus reports, and the TCU accordingly only updates information that differs. In contrast, at step 530 the TCU updates information for all modules and software installed in the vehicle and also updates the vehicle VIN in the table. This provides for an orderly operation of the TCU and efficient use of wireless bandwidth by waiting at step 570 and then partially updating at steps 575 and 540. For example, if a repair facility has to change out multiple modules before it corrects a problem, wireless bandwidth should not be used to upload an entire equipment information table after every module replacement and vehicle crank-up.

An aspect includes offering the providing of multiple telematics services and features to a subscriber, or potential subscriber, both of which may be hereinafter referred to as a ‘user.’ The services and features may be offered via the internet, via a wireless device separate from the telematics device, or via wireless circuitry of the telematics device itself. Thus, the services may be offered to, and received at, a location remote from a service provider's headquarters, or other business location, and remote from the user's vehicle. After receiving a remote offering of services, the user may make a selection from the offered services via an interface remote from the telematics unit for which the services are offered to be used in connection with. A message corresponding to the services the user selects is sent, from the user's interface to the service provider. The service provider receives the selection message and stores it to a server. The service provider uses the selection message that the user sends to provision the services that the user receives. Provisioning includes associating the selected services with an identifier of the user, and typically a password too, so that only the user can receive the selected services. Provisioning also includes modifying account billing associated with the user according to the current services selected. The services may be billed on a monthly basis, and may also be billed pro rata for the actual services the user subscribes to.

The identifier that identifies a user may include a subscriber identity module (“SIM”) that may he used in different telematics units, so that a selection of services follows a user, not a vehicle. On the other hand, the identifier may be a unique identifier embedded into a telematics unit, so that a subscriber pays for a set of selected services no matter who drives the vehicle the telematics unit is installed in. Regardless of the identifier used to link a user with an account and telematics services, the selection can be made, and received, from a location remote from, and with a device different from, a given vehicle, or a telematics device installed therein. Thus, for example, a user can select telematics services from an internet browser at their home or office, or using a wireless device, such as a cellular telephone, from anywhere with cellular service. The telematics device typically uses cellular wireless, and global positioning satellite, technologies to interface with networks, including the internet, cellular telephone networks, and satellite networks.

The user may log on to his, or her, account online using any one of the various, forms described above, or even other network access methods, such as entering a personal identification number (“PIN”) using a telephone and then entering selections from a menu using the telephone keypad. The interface device securely transmits the PIN, or other identifying log in information, such as a user name and password entered in a web browser, to the service provider's authorization system that authenticates the user's indentifying information. Once authenticated, the user can use the interface device to access a listing of services that the service provider's provisioning server makes available.

For example, a user may currently subscribe to cellular telephone service using his, or her, telematics device. However, the service provider may also offer Internet browsing and e-mail services via the telematics device. The user can log on to the service provider's web site via a home computer and place an order for the internet and e-mail services for use via the telematics device. The service provider can bill the subscriber by adding the services fee to the user's current billing plan, or, if the user is not a current subscriber, the user can provide credit card information to establish an account with services selected from the provider's web site.

To facilitate remote access to, and selection of, services provided through a telematics device, one or more services providers may have contracts with a central telematics system operator. The central operator may manufacture original equipment manufacturer (“OEM”) telematics systems that an auto maker installs in vehicles when they are assembled, or the central operator may also manufacture aftermarket telematics devices that a vehicle owner, or operator, can connect to, and use in, their vehicle. Or, the central operator may use devices manufactured by another party that the OEM or fleet manager installs in a vehicle.

The central operator may also provide emergency roadside assistance operators, and act as an intermediary that interacts with the user for central billing of all services. Thus, the central intermediary hosts a web site, for example, that provides users with password-protected, secure access to services that may be offered by a variety of providers. The web site displays the various features, content, services, software, and parameter options available for a user to select or edit, based on equipment, devices, software, content, other features, selected, etc. installed in, or configured in, a vehicle, and the user can use the interface to select which services, or package of services, that best meet his, or her, needs and budget. The user selects the services by clicking an icon, typing text, verbally stating a preference, clicking a link, for examples, for each of the desired features, content, services, software, and parameter options. Of course, other methods of identifying items in a list using an interne web page may also be used. For example, a drop down box, a dialog box that allows adding items from one list to another, etc. Thus, the user selects services remotely from, and independently of, a particular telematics device; however the selections are based on a current equipment, software, and content configuration of the vehicle.

When the central operator, or intermediary, receives a request to establish, or to modify, a selection of services to be delivered via a telematics system, the intermediary associates the new selection of services with the user's account and identifier in a user-subscription database. As discussed above, the identifier may be either a SIM card, and unique identifier related thereto, that links services with a user, thus allowing portability of services, or links services with the unique device identifier, thus tying an account to a particular device, whether it be permanently installed telematics device, or a portable telematics device that may be used in different vehicles by a user.

Based on the business relationships the intermediary has with various service providers, the intermediary bills the user for services and then pays a predetermined price to the actual service providers for each service a user subscribes to. A user can access the services by sending their identifier to the intermediaries server via its web site, which forwards the identifier and corresponding request to the user-subscription database, which is used to authenticate the user when he, or she, attempts to access the services subscribed to.

Another aspect includes a user entering login information, either manually, or via a device such as a SIM, a USB flash drive, a biometric sensor, etc. The device presenting the login interface forwards the login information to a central computer, such as a telematics operations center (“TOC”) central computer. The central computer performs a table lookup and retrieves information associated with the login information, such as financial account information associated with the login information. The table lookup may also return unique vehicle identification information, such as a vehicle identification number (“VIN”) that has been previously associated with the user's login information. Along with the VIN, the table also may associate equipment, software, and content installed on the vehicle corresponding to the VIN. By associating the equipment, software, and content installed or configured in a given vehicle, the central computer can make customized choices available to a user when the user accesses his vehicle configuration and account information via a user interface.

For example, for a given vehicle model, a first user may own a version with base model equipment. A second user may own a similar vehicle of the same make, model, and year, but instead of equipping it with a base equipment level, he equipped it with a high performance engine, or motor, a heavy duty regenerative braking system, and a higher voltage battery charging system than the base model. When the second user logs in to an interface using his login information, the central computer searches a user-vehicle table indexed on user login information and retrieves equipment information corresponding to the equipment level of the user's vehicle. The central computer presents to the second user certain options on an interface based on how his vehicle is equipped. For example, the interface may present the option to select between a 110 V AC and 220 V AC charging scheme, as opposed to base model vehicle only being equipped for 110 V AC charging. If the vehicle associated with the user's identifier is only equipped for 110 V AC charging, the interface may display the option for 220 V in a dimmed textual font.

If the second user selects 220 V charging, the central computer may download a message to a vehicle device, such as a telematics control unit (“TCU”) fixed to the second vehicle, indicating that the vehicle's user selected 220 V charging. The central computer might also detect the vehicle's location, based on latitude and longitude coordinates sensed with the TCU's GPS circuitry, and send a listing of all public charging stations that support 220 V charging within one and a predetermined geographic area surrounding the current location of the vehicle. Thus, the user has used his login information to remotely select options that affect operation and use of his vehicle.

The user may also enter charging preferences through the interface, which may be hosted by the central computer, or by a mobile wireless user device, or by the TCU installed in the vehicle. The TOC may transmit the selected preferences to the TCU, which may use the preferences to create a charging schedule to use for controlling charging of one or more batteries in the vehicle.

Other examples of such selections may include selecting a re-flash, or reprogramming, of a vehicle's engine and transmission control modules that provides high performance tuning of the vehicle as compared with the programming that the original manufacturer (“OEM”) sold with the vehicle. Using a device remote from the vehicle allows remote performance upgrades, and also remote performance downgrades to effectively ‘detune’ a vehicle's performance level if another person, such as the owner's son, or a thief, is driving the vehicle. The user may agree through the interface to pay, according to the financial account information, such as an account number, and rules, such as a maximum charge amount, associated with his login information, a third party for the re-flash programming, which the third party could download to the telematics unit after receiving payment therefor. As examples, the financial account could be a credit card account, or a telematics user's subscriber account.

As another example, a vehicle OEM may also use an interface provided by a telematics system to remotely reprogram operational features of a vehicle to mitigate the cost of performing upgrades as part of a mass vehicle recall effort, for example.

As another example, a user may remotely wish to download content (i.e., audio, video, text, navigation system database information, software applications including software to operate and enhance the performance of the vehicle as sell as no vehicle related software) to a device onboard the vehicle, such as a entertainment head unit, a telematics control unit, or other electronics device coupled with the telematics control unit.

In another aspect, the telematics system, comprising the TCU at the vehicle and the TOC central computer may recognize, or ‘learn’, when a modification has occurred to the equipment level, or programming of existing equipment, that someone has performed directly with, or to, the vehicle. For example, if a user installs aftermarket fuel injectors in an internal combustion engine of his vehicle, the telematics system may recognize the change automatically based on increased fuel delivery demands for a given engine RPM speed. Or, the vehicle on-board engine control module may have to adjust the injector duty cycle and spark advance to maintain proper performance of the vehicles with the new injectors. Or, the user may manually program the fuel and spark curve for the vehicle to achieve greater performance with the new injectors. The telematics system TCU could learn of the user's upgrades by comparing the values for various settings stored in the vehicles ECM memory, or by recognizing that the serial numbers of various electric and electronic modules installed in the vehicle have changed since a previous update of vehicle equipment information. These are just example of how the telematics system can learn of modifications, or replacements, to equipment that the vehicle manufacturer installed when it made the vehicle.

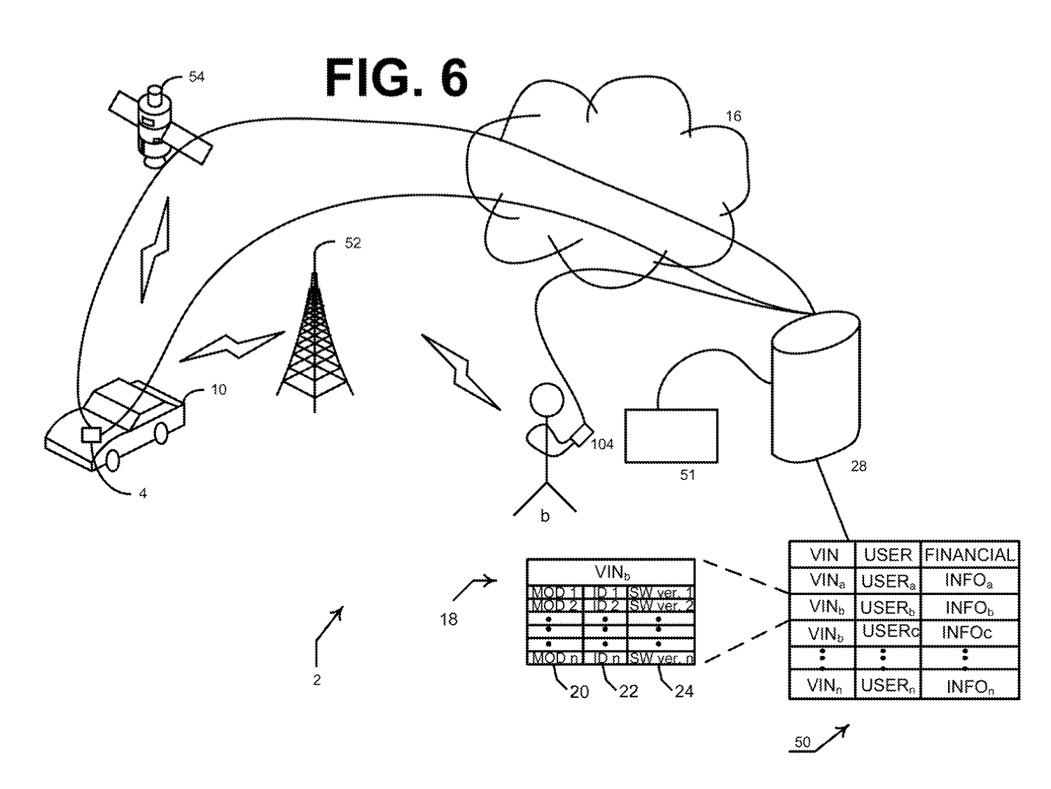

Turning now to FIG. 6, the figure illustrates additional aspects of system 2. Table 18 is an entry in configuration information table 50 corresponding to a vehicle having VINb. Preferably, a telematics services provider hosts table 50, which associates a VIN corresponding to a given vehicle with an identifier of a user, typically an owner of the vehicle, and with financial information of the corresponding user. In the example shown in the figure, table 18 associates electronic modules 20 with corresponding module identifiers 22 and the current software versions 24 configured into the modules. Table 18 may also associate other configuration information such as stored content, selected features, and operational parameter settings with the corresponding VIN. User b may use a handheld wireless device 104, personal computer 51, or other device to enter login information, edit feature selections, and select features that may be available based on equipment, software, or content installed in the vehicle or based on current preferences, data, or software versions loaded into, or associated with, various modules in the vehicle. TCU 4 may use satellite system 54, or a wireless communication network 52, or both, to communicate with telematics server 28.

In an aspect, table 50 may associate multiple users with the same VIN. For example, user b may be the owner of vehicle 10, but a financial organization c that lent money to user b to purchase vehicle 10 may also have an entry USERc (not shown in the figure) in table 50 associated with VINb. The lender that financed the purchase of vehicle 10 may wish to track the vehicle for purposes of recovering the vehicle if a thief steals it, or for monitoring the miles driven if the financing was in the form of a lease with a maximum number of allowed miles. Thus, a telematics services provider can prepare a telematics bill for user b based on a periodic subscription fee, and also based on selected features, content, services, software, and parameter options that he selected during a billing cycle. In addition, the telematics services provider can also prepare a separate bill for the services that the financial organization used for a billing cycle.

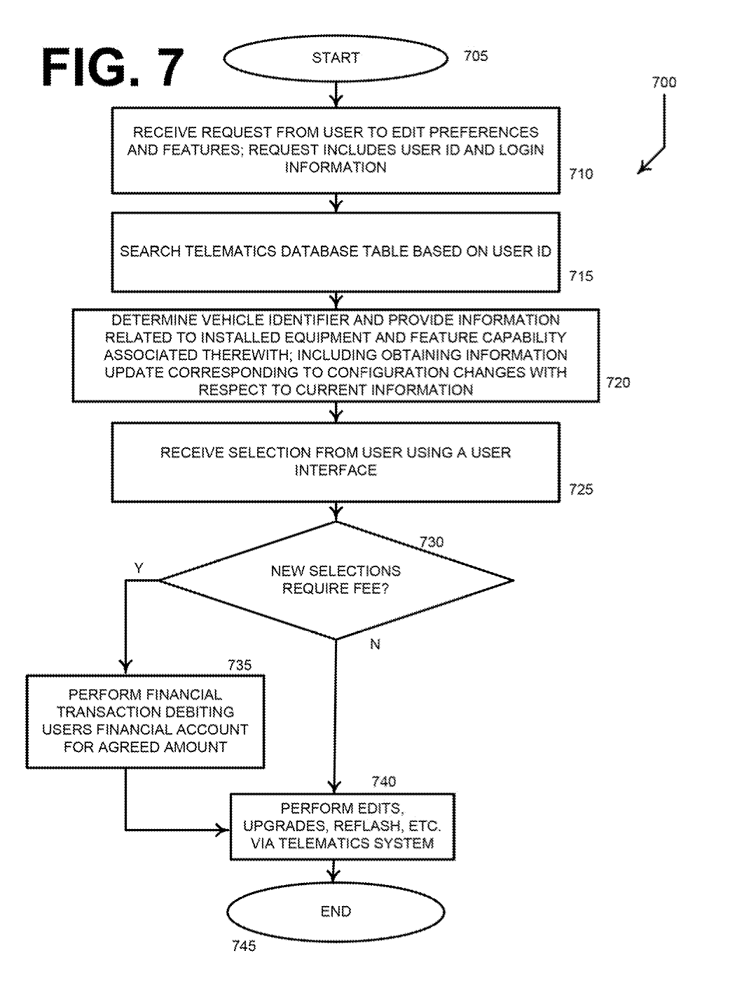

Turning now to FIG. 7, the figure illustrates a method 700 for editing selections and preferences for features, content, services, software, and parameter options available for equipment, software, and content installed and configured in a vehicle. Method 700 starts at step 705 and proceeds to step 710, where a central computer, for example a telematics provider's server, receives a request message from a user interface to update features, content, services, software, and parameter options related to a user's vehicle. The user enters his login information through the user interface, such as a web page on a browser, or an application running on a computer or smartphone, or similar user device, and the interface forwards the login information to the central computer.

Based on the received user login information, the central computer searches a telematics table at step 710 and locates a record matching the login information. The matching record typically associates a VIN and a user's financial information, such as a credit account number, with the login information.

At step 715, the central computer determines the VIN that matches the login information of the user, and locates information particular to the corresponding vehicle and equipment, software, and content installed and configured therein. The vehicle information may be in a separate table 18 that relates records to the telematics database 50 according to VIN. Or, the vehicle information may be part of the same table 50 in the record corresponding to the matching VIN. If separate, tables 18 and 50 may be distributed across computer platforms.

Before providing the vehicle information that matches the VIN to the user interface, the central computer 28 may query the vehicle to determine whether the vehicle information shown in the figure as table 18 is current. Typically, the vehicle TCU may be programmed to report current module status of installed equipment, software and content to the central computer periodically, or at every crank up, or at some other predetermined interval or trigger. Or, the TCU may only update the central computer when an equipment change is made. At some point, the information stored in table 18 may not matched the equipment installed in the vehicle or the software versions loaded in various vehicle modules may not match the information stored in table 18. Thus, the TCU may also update table 18 with information relative to its corresponding vehicle's installed equipment, software, and software upon a query by the central computer at step 720. The central computer may then present the current configuration of equipment, software, and content via the user interface at step 720.

After the central computer has updated the vehicle information in table 18, and displayed current configuration information, the central computer receives input from the user interface requesting the presentation of configurable features, content, services, software, and parameter options, or other editable information associated with a particular piece of equipment, software, or content currently configured in the vehicle. For example, a user may wish to make performance changes to engine operating parameters. This would typically involve edits to the engine control module software. Or, a user may wish to make changes to a song play list loaded on the audio head unit module in the vehicle. Or, a user may wish to edit a charging schedule for the batteries if the vehicle is an electric vehicle.

If the user uses the interface to request the presentation of the current song list saved in the vehicle's head unit, the central computer forwards song list information to the user interface, which then can display the list in a predetermined format, and then provide an interface that allows the user cut, copy or paste, for example, content to and from the TCU and another device. The user performs his preferred selecting or editing action at step 725.

At step 730, the central computer determines whether the selected edit or other action requires a fee from the user. If so, for example copying a sing from a web site to the TCU may require a download fee, central computer retrieves financial information from the record in table 50 associated with the user login information, and then debits the associated financial account accordingly at step 735. At step 740, the central computer performs, or facilitates, the requested selections, edits, or downloads, and method 700 ends at step 745. If the central computer determined at step 730 that the user's selection, or requested action, does not require a fee, method 700 proceeds to step 740 and continues as described above.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for configuring a vehicle, comprising:
receiving login information;
determining the configuration of at least one of equipment, devices, features, software, services, and content associated with the login information;
presenting, via a user interface, available features, content, services, software, and parameter options, which the user may select or edit, based on at least one of the equipment, devices, features, software, services, and content currently configured in the vehicle;
receiving a selection or edit of one or more features, content, services, software, and parameter options from the user interface; and
provisioning at least one of the equipment, devices, features, software, services, and content according to the one or more selected or edited features, content, services, software, and parameter options.

2. The method of claim 1, wherein a user entering login information to the user interface is one of personnel, or computer equipment, of: a vehicle manufacturer, a vehicle dealer, a financial organization having an interest in the vehicle, a law enforcement agency, a vehicle fleet operator, and an individual vehicle owner.

3. The method of claim 1, wherein the configurable features, content, services, software, and parameter options include: stolen vehicle tracking, teen tracking, remote lock and unlock, remote start, remote disable, providing vehicle run status, remote arming and disarming of alarm, remote horn activation and light flashing, remote operation of windows and trunk, vehicle location determination, geo fencing, targeted area marketing, providing preferred daily route services, vehicle diagnostic check, providing remote emissions status, pollutant monitoring, carbon dioxide monitoring, remote emissions status determination, providing of daily drive/vehicle operations statistics, providing accident assistance services, providing customer account and profile information, providing real time traffic and weather information, providing news information, providing low price fuel information, providing city guide and point of interest information, providing movie listings, facilitating mobile commerce services, providing dealer location services, providing owner's manual and maintenance information, providing maintenance alerts and reminders, providing customer care services, providing dealer coupons and special service offers, facilitating the requesting of emergency service, roadside assistance, concierge service, media content download, mobile commerce, navigation database, navigation services, traffic service, engine control module operational and performance parameters, software version and image corresponding to the installed equipment, media content files that installed equipment can play.

4. The method of claim 1, wherein determining the configuration includes receiving one, or more, update messages wirelessly transmitted from the vehicle that associate current vehicle configuration information with a vehicle identifier.

5. The method of claim 4, wherein an update message includes at least one of software version information, software filename information, and serial number information corresponding to equipment installed in the vehicle.

6. The method of claim 4, wherein an update message includes information indicative of media content configured for the vehicle.

7. The method of claim 1, wherein the presenting for editing or selecting one or more features, content, services, software, and parameter options depends on the configuration status of another feature, content, service, software, or parameter option.

8. The method of claim 1, further comprising generating a telematics bill corresponding to the login information, based on selected or edited features, content, services, software, and parameter options.

9. The method of claim 1, further comprising receiving a period message from the user interface indicating a period over which the configuration of selected or edited features, content, services, software, and parameter options should be effective.

10. The method of claim 1, further comprising transmitting a request for authorization to a remote server operated by a provider of desired service, wherein the provider of the desired service is a provider of software for operating an electronic module installed in the user's vehicle.

11. The method of claim 1, further comprising transmitting a request for authorization to a remote server operated by a provider of desired service, wherein the provider of the desired service is a provider of software for operating an electronic module installed in the user's vehicle.

12. The method of claim 1, wherein provisioning comprises at least one of, enabling or disabling one or more of: features, the playing of content, services, software, and parameter options.

13. A telematics apparatus for configuring a vehicle, comprising:
a memory, configured for storing configuration settings of selected features, content, services, software, and parameter options corresponding to one, or more devices, software, software, content files, installed and saved in the vehicle;
a processor, configured to manage the provisioning of the configuration settings of the features, content, services, software, and parameter options.

14. The apparatus of claim 13, wherein the apparatus is coupled to devices and equipment installed in the vehicle, and wherein the processor can interface with software and content files installed and stored in the devices and equipment.

15. The apparatus of claim 13, wherein the configurable features, content, services, software, and parameter options include: stolen vehicle tracking, teen tracking, remote lock and unlock, remote start, remote disable, providing vehicle run status, remote arming and disarming of alarm, remote horn activation and light flashing, remote operation of windows and trunk, vehicle location determination, geo fencing, targeted area marketing, providing preferred daily route services, vehicle diagnostic check, providing remote emissions status, pollutant monitoring, carbon dioxide monitoring, remote emissions status determination, providing of daily drive/vehicle operations statistics, providing accident assistance services, providing customer account and profile information, providing real time traffic and weather information, providing news information, providing low price fuel information, providing city guide and point of interest information, providing movie listings, facilitating mobile commerce services, providing dealer location services, providing owner's manual and maintenance information, providing maintenance alerts and reminders, providing customer care services, providing dealer coupons and special service offers, facilitating the requesting of emergency service, roadside assistance, concierge service, media content download, mobile commerce, navigation database, navigation services, traffic service, engine control module operational and performance parameters, software version and image corresponding to the installed equipment, media content files that installed equipment can play.

16. The apparatus of claim 13, further comprising a wireless transceiver coupled with the processor, configured to communicate with a telematics server.

17. The apparatus of claim 16, wherein the processor is further configured for:
causing the transceiver to transmit a request for provisioning authorization to the telematics server; and
processing an authorization, received from the telematics server via the transceiver, to provision the configurable features, content, services, software, and parameter options.

18. The apparatus of claim 13, wherein provisioning comprises at least one of, enabling or disabling one, or more, of the configurable features, content, services, software, and parameter options.

19. A telematics server, configured for:
receiving login information;
determining the configuration of at least one of equipment, devices, features, software, services, and content associated with the login information;
presenting, via a user interface, available features, content, services, software, and parameter options, which the user may select or edit, based on at least one of the equipment, devices, features, software, services, and content currently configured in a vehicle;
receiving a selection or edit of one or more features, content, services, software, and parameter options from the user interface; and
provisioning at least one of the equipment, devices, features, software, services, and content according to the one or more selected or edited features, content, services, software, and parameter options.

20. The system of claim 19, wherein determining the configuration includes receiving one, or more, update messages wirelessly transmitted from a device associated with the vehicle that associate current vehicle configuration information with a vehicle identifier.
